(19) United States
(12) Patent Application Publication
(10) Pub. No.: US 2005/0273981 A1
(43) Pub. Date: Dec. 15, 2005

(54) Securement devices for bibs and the like

(75) Inventors: Kim Porter Henneman, Portland, OR (US); Ichiang Sun, Portland, OR (US); Diane Murdock Evershed, Lake Oswego, OR (US)

Correspondence Address: STOEL RIVES LLP, 900 SW FIFTH AVENUE, SUITE 2600, PORTLAND, OR, 97204-1268, US

(73) Assignee: Kipiis, LLC, Lake Oswego, OR (US)

(21) Appl. No.: 11/118,069

(22) Filed: Apr. 29, 2005

Related U.S. Application Data
(63) Continuation-in-part of application No. 29/199,261, filed on Feb. 11, 2004.

(51) Int. Cl. A61D 1/10

(52) U.S. Cl. 24/9

(57) ABSTRACT

A securement device for adjustably holding an element in a desired position. In a preferred application, the device holds a napkin or drape in position on a person's shirt-front, the device having first and second cord sections, each cord section having a clip mechanism attached on its distal end, and a slide mechanism interconnecting the first and second cord sections adjacent proximate ends thereof, wherein each of the first and second cord sections are slidably movable through the slide element providing for length adjustment enabling positioning of a napkin or drape in a desired position over the user's shirt-front forming a bib.

### RELATED APPLICATION DATA

This application is a continuation in part of U.S. application Ser. No. 29/199,261 filed Feb. 11, 2004, hereby incorporated by reference.

### BACKGROUND

The field of the present invention relates generally to securement devices, bibs and bib holder devices.

There have been many designs for bibs of various materials and with various attachment schemes. In some situations, a bib is not available and it is desirable to use another article, such as a napkin, in securing the napkin in place at the person's shirt front.

There have been many mechanisms proposed for securing an article such as a napkin at a person's shirt front. For example, in a dentist's office, a cord or chain with an alligator clip disposed on opposite ends is positioned around a user's neck and clipped to a paper napkin to position the napkin at the patient's shirt front. Other napkin holders have been proposed such as disclosed in U.S. Pat. Nos. 324,039; 4,587,692, and 5,191,681. These designs provide some functionality but are otherwise aesthetically deficient.

The present inventors have determined the desirability for design of a napkin supporter or the like that is both functionally versatile and aesthetically pleasing.

### BRIEF DESCRIPTION OF THE DRAWINGS

FIG. 1 is a top front right perspective view of a bib clip, according to a first embodiment.

FIG. 2 is a bottom front left perspective view of the bib clip of FIG. 1.

FIG. 3 is a front elevation view of the bib clip of FIG. 1.

FIG. 4 is a rear elevation view of the bib clip of FIG. 1.

FIG. 5 is a left side elevation view of the bib clip of FIG. 1.

FIG. 6 is a top front right perspective view of the clip and cord element of the bib clip of FIG. 1.

FIG. 7 is a bottom front left perspective view thereof.

FIG. 8 is a front elevation view thereof.

FIG. 9 is a rear elevation view thereof.

FIG. 10 is a left side elevation view thereof.

FIG. 11 is a top front right perspective view of a clip element for the bib clip or other article.

FIG. 12 is a bottom front left perspective view thereof.

FIG. 13 is a front elevation view thereof.

FIG. 14 is a rear elevation view.

FIG. 15 is a left side elevation view thereof.

FIG. 16 is a top front right perspective view of the slide element for the bib clip of FIG. 1.

FIG. 17 is a bottom front left perspective view thereof.

FIG. 18 is a front elevation view thereof.

FIG. 19 is a rear elevation view.

FIG. 20 is a left side elevation view thereof.

FIG. 21 is a perspective view of the inside surface of the front half of the slide element of FIG. 1.

FIG. 22 is a perspective view of the inside of the rear section of the slide element of FIG. 1.

FIG. 23 is an exploded view of the body sections of the clip element of FIG. 1.

FIG. 24 is a perspective view of the bottom side of the top section of the clip element of FIG. 23.

FIG. 25 is a bottom view of the center section of the clip element of FIG. 23.

FIG. 26 is a perspective view of the spring element for the clip element of FIGS. 1 and 23.

FIG. 27 is a perspective view of a preferred configuration for each of the two cords of the bib clip configuration of FIG. 1.

FIG. 28 is a detail on an enlarged scale of the end section of the cord of FIG. 27.

FIG. 29 is a perspective view of a cord comprised of a single looping cord design, such as may be substituted for the two cords of the embodiment of FIG. 1.

FIG. 30 is a perspective view of an alternate securement device with a singular looped cord element.

FIG. 31 is a perspective view of an alternate configuration of the slide adjustment mechanism.

FIG. 32 is a perspective view of an alternate securement device having a flexible length adjustment mechanism.

FIG. 33 is a detail of the adjustable length mechanism of FIG. 32 in a stretched condition.

FIG. 34 is a perspective view of a securement device according to another alternate embodiment.

FIG. 35 is a detailed view of the connection element mechanism of FIG. 34.

FIG. 36 is a prospective view of a securement device according to another alternate embodiment with another length adjustment mechanism.

FIG. 37 is a perspective view of a securement device according to another alternate embodiment with another length adjustment mechanism.

FIG. 38 is a detailed view of the length adjustment mechanism of FIG. 37.

FIG. 39 is a perspective view of an alternate clip mechanism and cord attachment configuration.

### DETAILED DESCRIPTION OF PREFERRED EMBODIMENTS

The preferred embodiments will now be described with reference to the drawings. For ease of description, an element numeral used to represent an element in one figure will be used to represent the same element in any other figure.

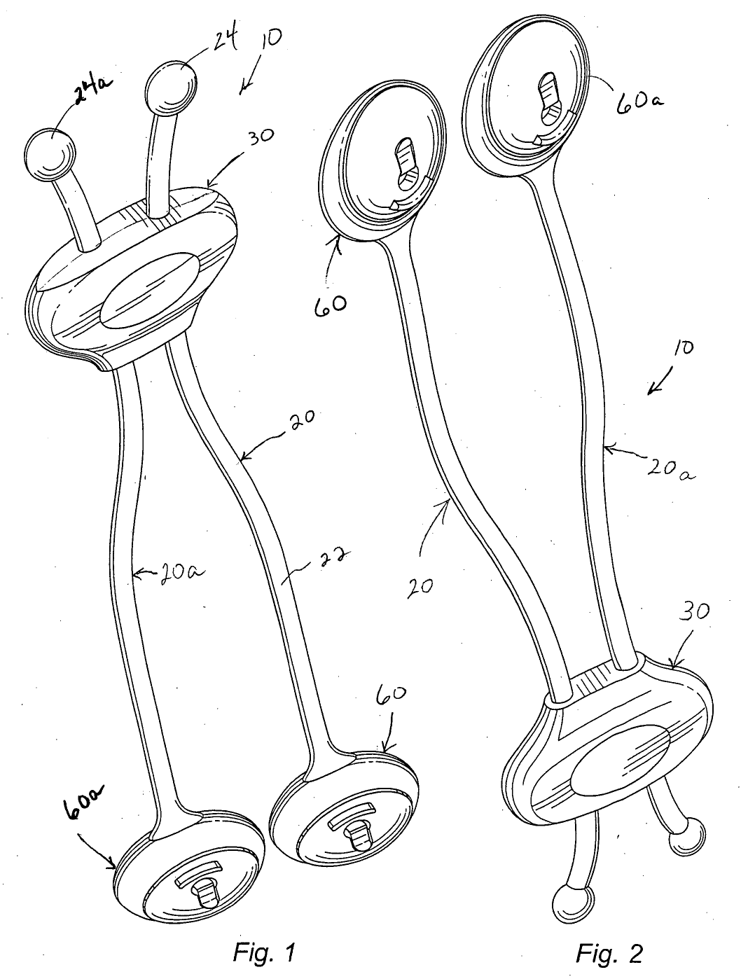

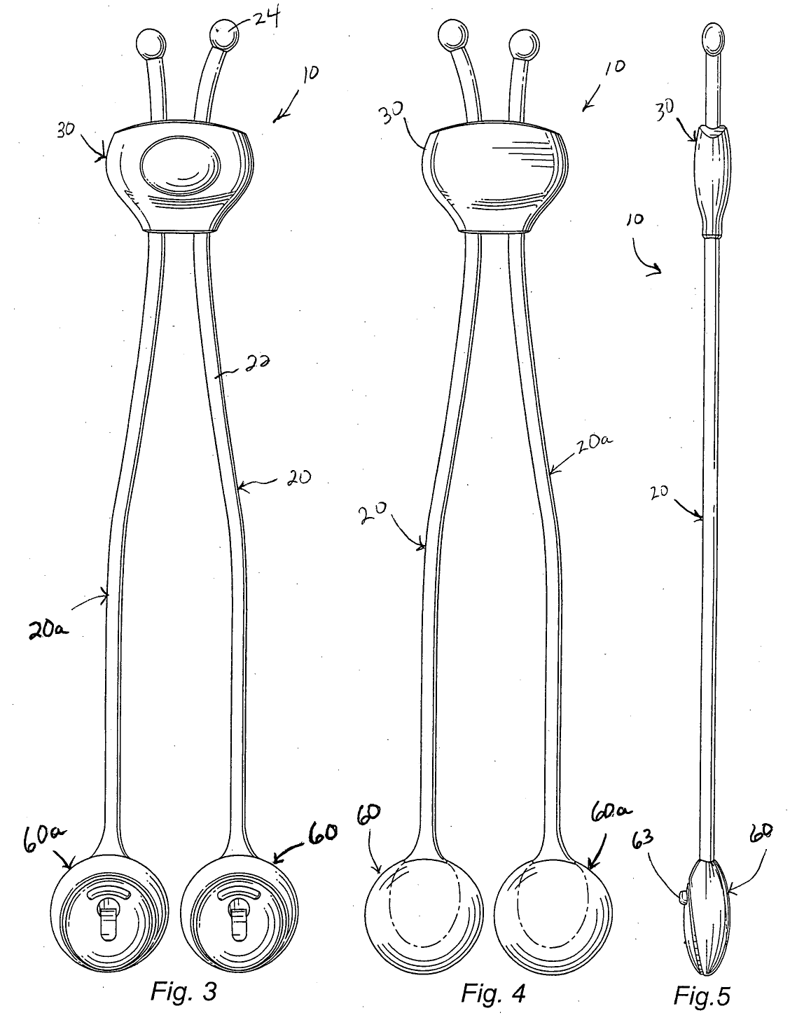

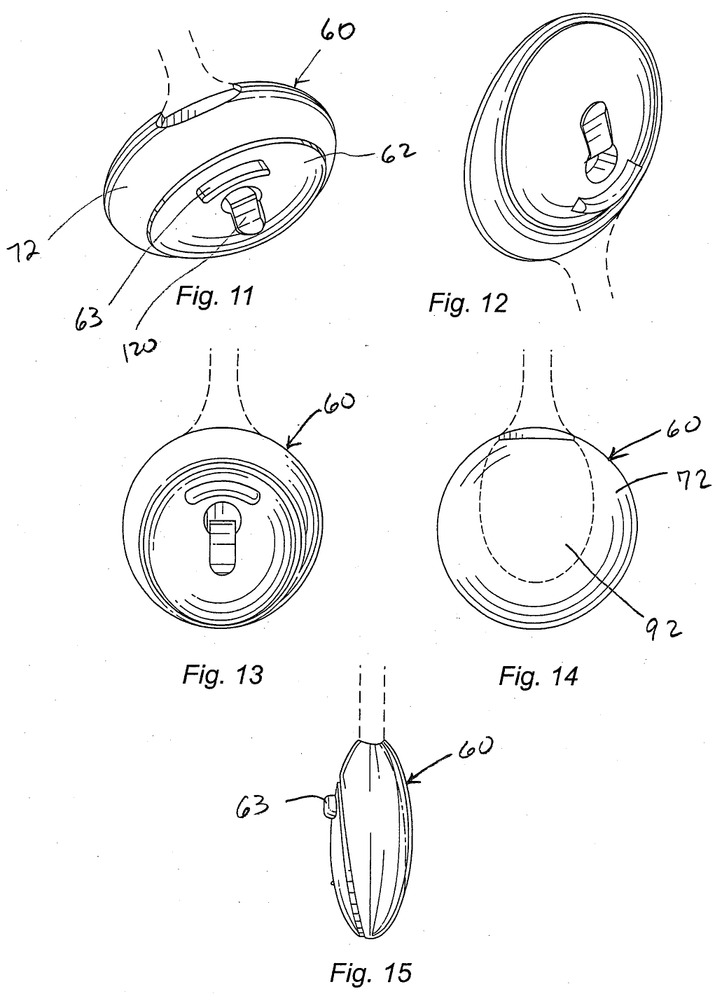

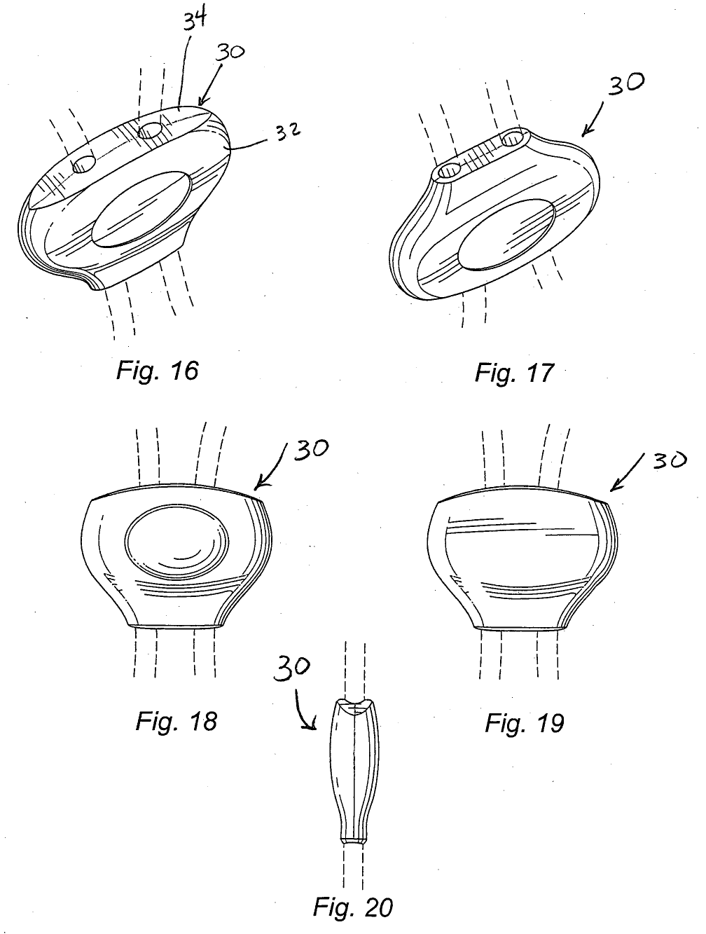

FIGS. 1-28 illustrate a bib clip device 10 according to a first preferred embodiment. Device 10 includes a slider section 30, first and second leg sections 20, 20a and end clips 60, 60a, each of the end clips being secured at the distal end of respective leg sections 20, 20a. Each of the leg sections 20, 20a are identical and their respective end clips 60, 60a are also identical, thus description of the details of the leg section 20 and end clip 60 are equally applicable to the leg section 20a and end clip 60a.

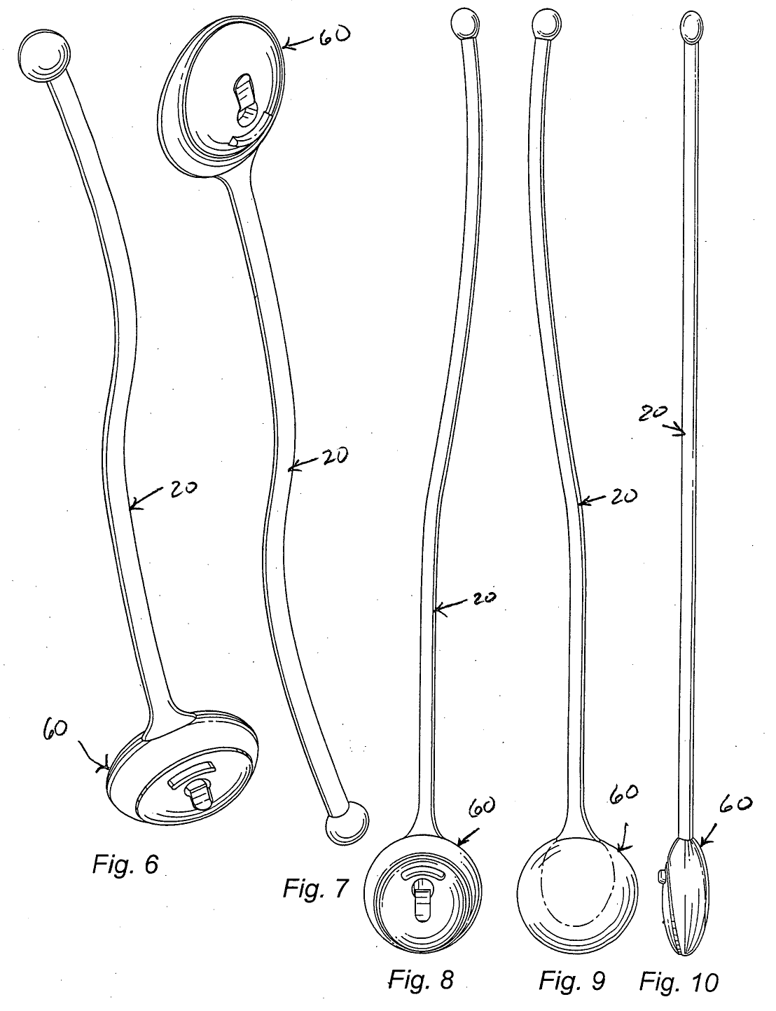

The leg section 20, as best illustrated in FIGS. 6-10 and FIGS. 27-28, is an elongated cord-shaped device preferably made of a flexible rubberized plastic material manufactured in a single molding process. The cord 20 has a central section 22 molded to form, when at rest, an elastic curvature in an S-curve as best illustrated in FIG. 27. The S-curve shape may provide for a spring-like action enhancing user comfort while wearing the device. The top or proximate end of the cord section 20 terminates at and is formed with an enlarged section in the form of a ball 24. The ball 24 is both an aesthetic feature and functional feature. Being an enlargement from the round cross-section of the central cord section 22, the ball 24 inhibits the cord from being passed through the opening in the slider 30 during adjustment as will be described in further detail below. On the bottom or distal end of the cord 20 is an end connector 25 comprised of a flared section 26 which has a generally oval cross-section when viewed from the bottom along the longitudinal axis of the cord with a circular flared end 28. The flared end appears in the shape of a disc attached to the flared end 26 via a reduced diameter section 27 therebetween.

The end clip 60 is assembled and secured onto the end section 25 of the cord 20. Details of the end clip 60 are best viewed with reference to FIGS. 23-26. FIG. 23 is an exploded view of the end clip 60 as having three primary sections, namely the top section 62, center section 72 and bottom section 92. The other component of the end clip 60 is the spring 120 illustrated in FIG. 26.

The top section 62 comprises an upper domed surface 64 with an offset aperture 66. Also central to the top dome section is an indented surface 68 that concludes at a shoulder or ridge portion 69. Also on the top surface 64 is an outwardly extending ridge 63 which accommodates grasping as will be described further below. FIG. 24 illustrates the underside of the top section 62. An outer ridge 61 extends along the lower half of the outer circumference on the underside of the element. As viewed in FIG. 24, the central aperture 66 passes through the element. On the underside there are a pair of protruding posts 71, 71 which align with and engage into holes 76, 76 within the center section 72. A rocker 70 extends between the posts 71, 71 and engages the corresponding rocker 78 in the center section 72.

The center section 72 is also a generally round or oval element with an indentation 74 on the top side for accepting the upper section 62. The central section 72 includes a center platform 75 within the indentation 74. The platform includes a pair of holes 76, 76 which align with and engage the posts 71, 71 of the upper section 62. At the distal end of the central section 72 is a recessed ridge 77 which engages the ridge 61 of the upper section 62. A rocker 78 is disposed between the holes 76, 76.

On the underside of the center section 72, as shown in FIG. 25, there is an indentation 79 on the proximate end for accommodating the bottom section 92.

The cord end 25 is secured as sandwiched between the central section 72 and the bottom section 92. The central section has an oval-shaped opening 80 at the distal end adjacent a narrower semicircular opening 81 which in turn is adjacent a larger semicircular opening 83.

The bottom section 92 includes an upwardly extending distal ridge 97 of approximately a semi-circular form which engages within the indentation 79 of the central section 72. At the proximate end the bottom section 92 has ridges 95, 95 which engage within the proximate indentations 85 in the central section 72. Both the distal ridge 97 and the proximate ridges 95, 95 are shown with ultrasonic weld energy director material 98 disposed over the top surface. This material 98 will melt during the ultrasonic welding process to form the bond between the contacting surfaces to secure the bottom section 92 to the central section 72.

The mechanical clip section is assembled by attaching the upper section 62 onto the central section 72 via a U-shaped leaf spring 120 illustrated in FIG. 26. The spring 120 snaps in place with the central section 126 disposed within the hole 66 of the upper section 62, the upper spring leg 122 disposed across the flat section 68 with the tip of the leg 123 engaging the ridge 69 and the bottom spring leg 124 disposed past the ridge 87 along the underside of the central section 72.

When in place, the spring 120 urges distal end of the upper section 64 into contact with the distal end of the central section 72. A user may squeeze the clip 60 such as by the thumb engaging the raised ridge 63 opening a “mouth” between the upper section 62 and the lower section 72 into which an article such as the edge of a napkin may be inserted and once released the spring 120 urges the sections back together closing the mouth and securing the napkin edge in place. Internal surfaces in the mouth may comprise ridges or teeth to engage the napkin surface more securely when the mouth is closed.

The bottom section of the device is then assembled by inserting the end section 25 of the cord between the bottom section 92 and the upper section 72. The small diameter section 27 of the cord is positioned between opening 81 of the central section and opening 96 of the bottom section; the oval section 26 of the cord is positioned within the corresponding oval openings 80 of the central section and 94 of the bottom section. Once the cord end 25 is in position, the central section 72 and the bottom section 92 are assembled together and ultrasonically welded.

Other types of assembly mechanisms for the clip assembly sections such as a snap-fit, adhesives or other suitable connections may be utilized.

Once the central section 72 and bottom section 92 are secured together, the end section 25 is firmly secured in place with the larger diameter disc portion 28 internal to the aperture formed between the semicircular openings 81 and 96. The cord end 25 itself may be secured in place merely by mechanical fit or itself or may be ultrasonically welded in place, secured by adhesives, or secured by any suitable mechanism.

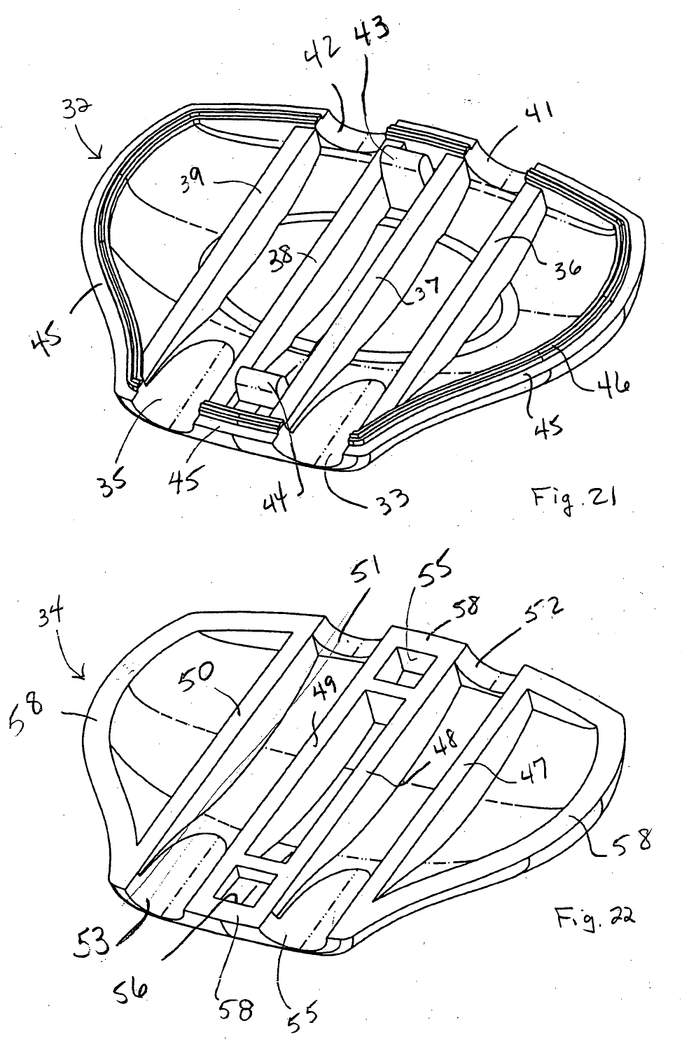

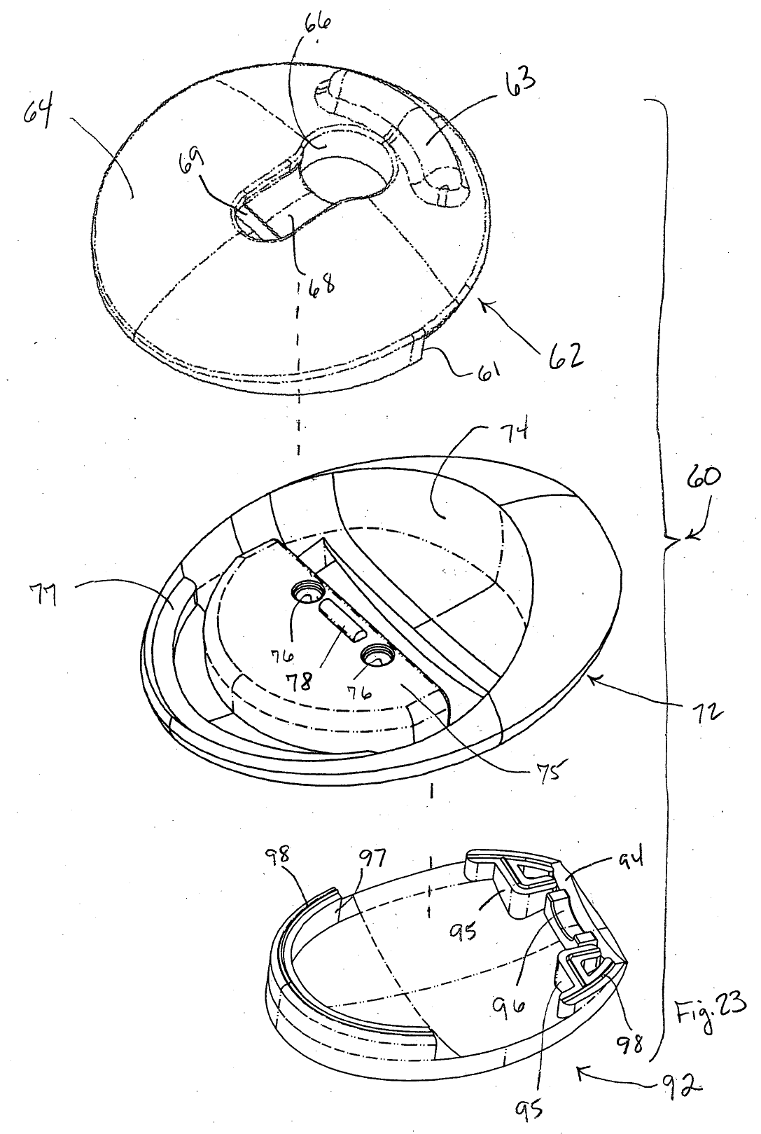

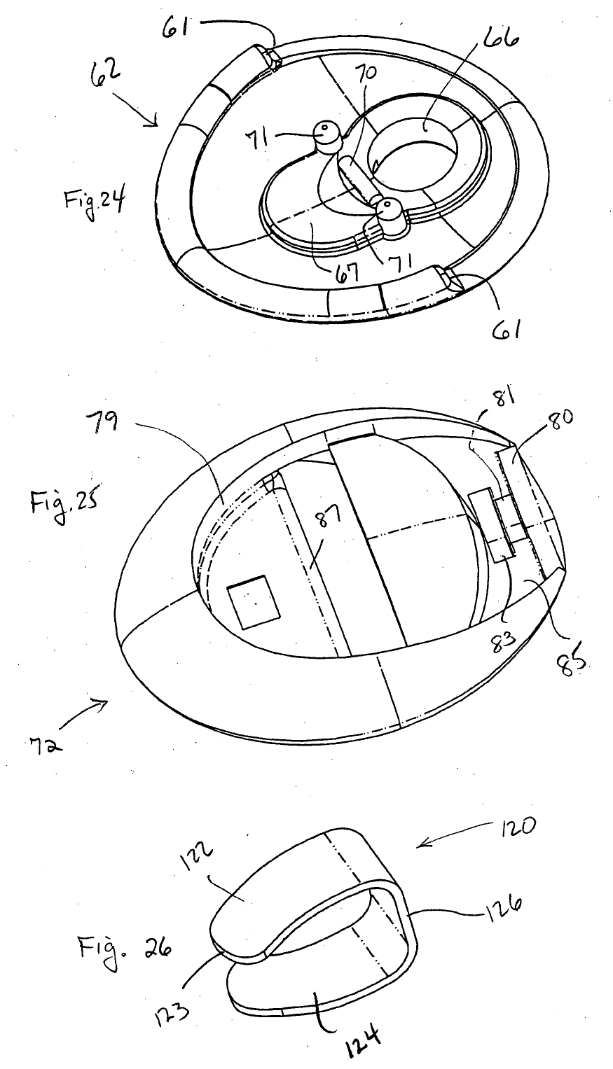

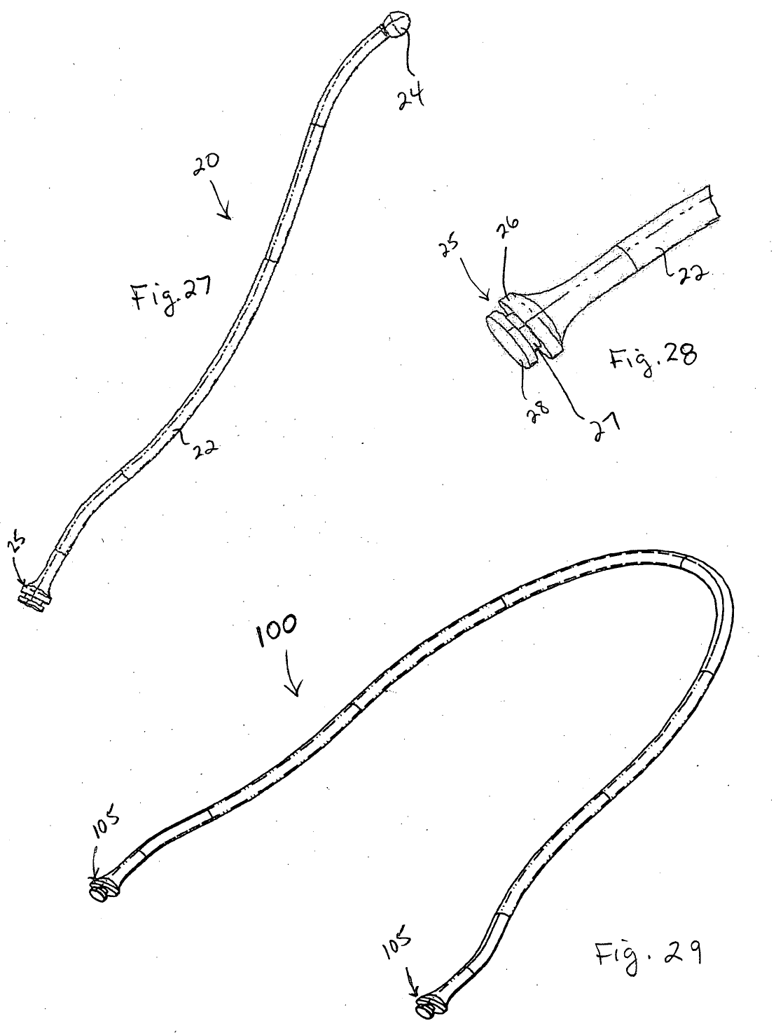

The slide mechanism 30 is actually formed in two sections, a front section 32 and a rear section 34 that are ultrasonically welded together about the cords 20, 20a. Details of the front and rear sections 32, 34 are illustrated in FIGS. 21 and 22.

The front section 32 has a generally rounded front surface as visible in FIG. 1 and an indented inner surface as visible in FIG. 21. A pair of length-wise bars 36, 37 forms a channel extending between the top edge opening 41 and the lower edge opening 33 for accommodating cord 20a. Similarly, on the other side bars 38, 39 form a channel between semicircular opening 42 at the top and, opening 35 at the bottom for accommodating the cord 20.

The rear section 34 includes a similar structure with bars 47, 48 forming a channel between semicircular end opening 52 on the top end and opening 55 on the bottom end. On the other side bars 49, 50 form a channel extending from the top semicircular opening 51 and the bottom opening 53. The front section 32 includes alignment tabs 43 and 44 which engage into corresponding alignment opening 55, 56 in the lower section 34. The outer periphery of the front section 32 has a flat engagement surface 45 for engaging a corresponding flat surface 58 around the outer periphery of the rear section 34.

FIG. 21 illustrates the front section 32 with an ultrasonic weld energy direction material 46 disposed along the flat outer peripheral surface 45. During assembly, the cords 20, 20a are placed within the respective channels and the front section 32 and the rear section 34 are engaged together with the tabs 43, 44 engaging into respective alignment openings 55, 56. Once aligned and pressed together, the components are ultrasonically welded together, melting the material 46 to form a permanent connection or bond therebetween. Other attachment mechanisms may be utilized such as snap fit, adhesive, or other suitable mechanisms.

Once the slide sections 32, 34 are assembled, the cords are reasonably secured in place by a loose friction fit within the respective channels. However, the length of the cord beneath the slide 30 may be adjusted by pulling on either end of the cord, thereby adjusting the position of the respective clip 40, 40a at the desired position on the wearer's chest.

Alternately, the fit provided by the slide may be configured sufficiently tight so that the unit is not adjustable or the cord may be welded or otherwise bonded in place.

FIG. 29 illustrates an alternate cord 100, having cord ends 105 with the same configurations as end 25 of unit 20 of FIG. 27. As opposed to the previous embodiment with two separate cord elements, the cord 100 includes a single looped cord element. End clips 60 and 60a may be secured to cord ends 105, 105 in similar fashion as in the previous embodiment. The cord 100 may be used in one embodiment without a slide with the curved end merely extending around the neck of the user.

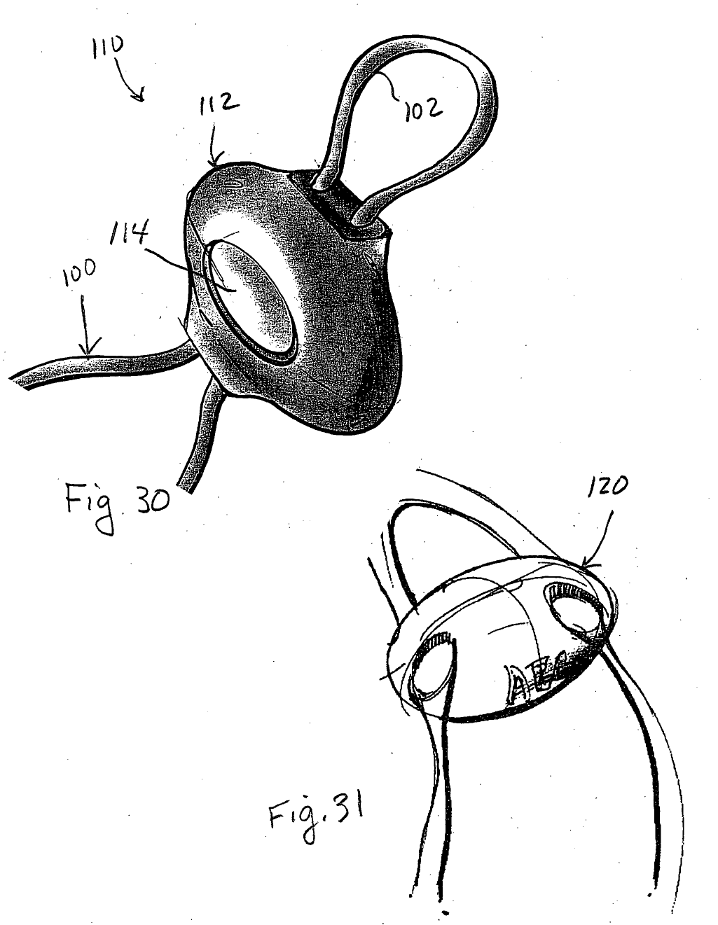

Alternately, the cord 100 may be modified adding a slide unit 30 as in the previous embodiment to provide a desirable adjustment feature similar to that previous disclosed. FIG. 30 illustrates a top portion of an alternate bib clip device 110 including the single cord 100 with a top loop portion 102 above the slide element 112.

Other configurations for the slide element 30 may be used. For example, the slide element 112 of FIG. 30 which otherwise has a similar configuration to the slide unit 30 may include a release mechanism for allowing the sliding adjustment of the cord 100. The release mechanism may comprise for example, an internal engagement mechanism which normally prevents the sliding movement of the cord 100 but upon pressing of the button 114 releases the cord to allow easy adjustment. Upon release of the button 114, engagement is reapplied and the cord is locked in the new position.

Other shapes for the slide element may also be employed. FIG. 31 illustrates another configuration of a slide 120 having a more oblong or egg-shape. The openings for the cord sections are laterally displaced to outer edges providing a wider connection behind the user's neck which might provide for a more comfortable fit engagement. The slide 120 may of course be used either with the single cord configuration as illustrated in FIG. 31 or may alternately employ the two cord configuration of a previous embodiment.

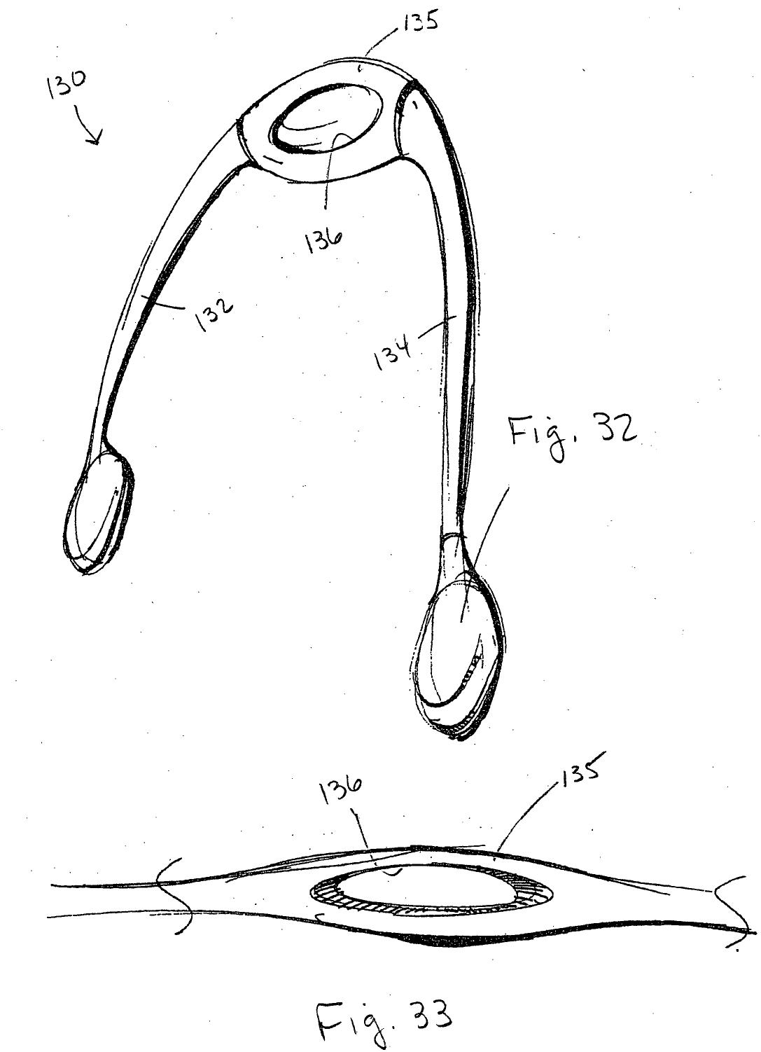

FIGS. 32-33 illustrate another alternative embodiment of a bib clip or attachment device 130 with cord legs 132, 134 attached by flexible element 135. The flexible element 135 is formed from a flexible rubberized material similar to the material of the cords and configured to form a generally circular internal aperture 136. When the ends of the cord are pulled apart, the section 135 can flex or otherwise readily stretch, as shown in FIG. 33, due to the configuration of the aperture 136.

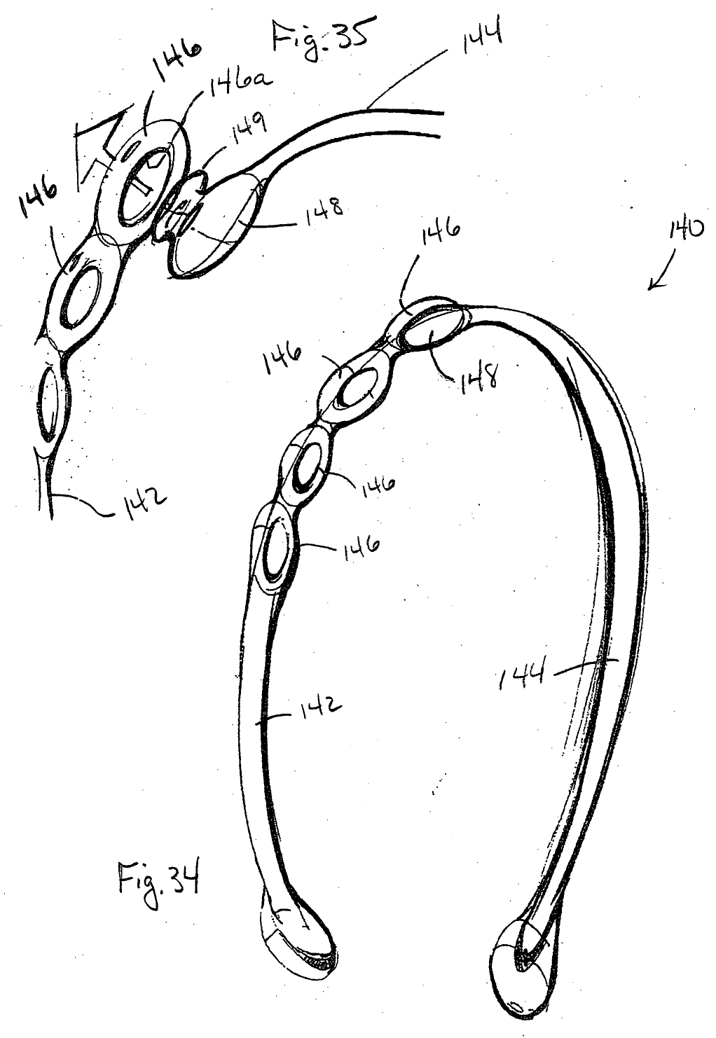

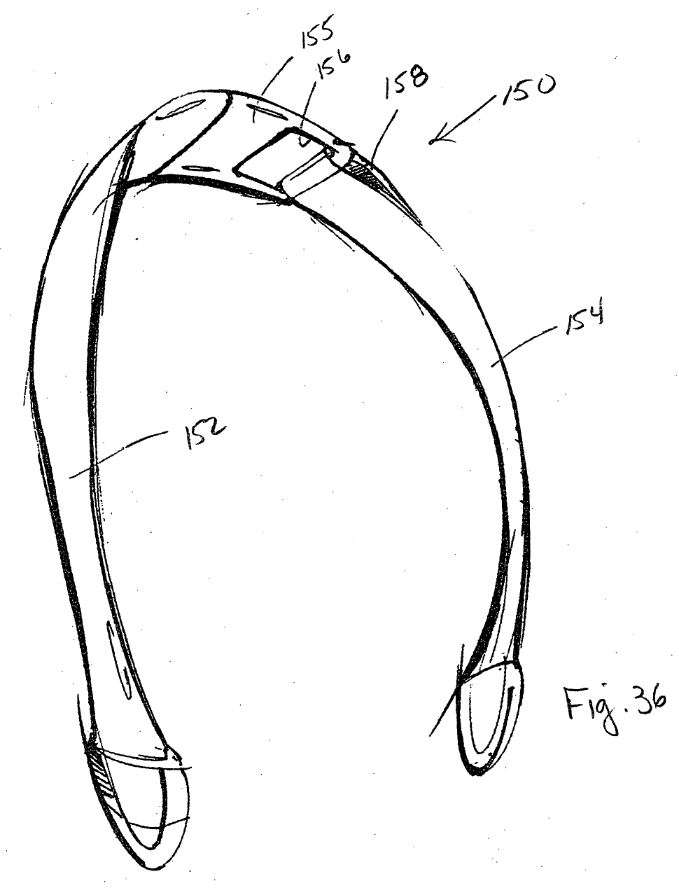

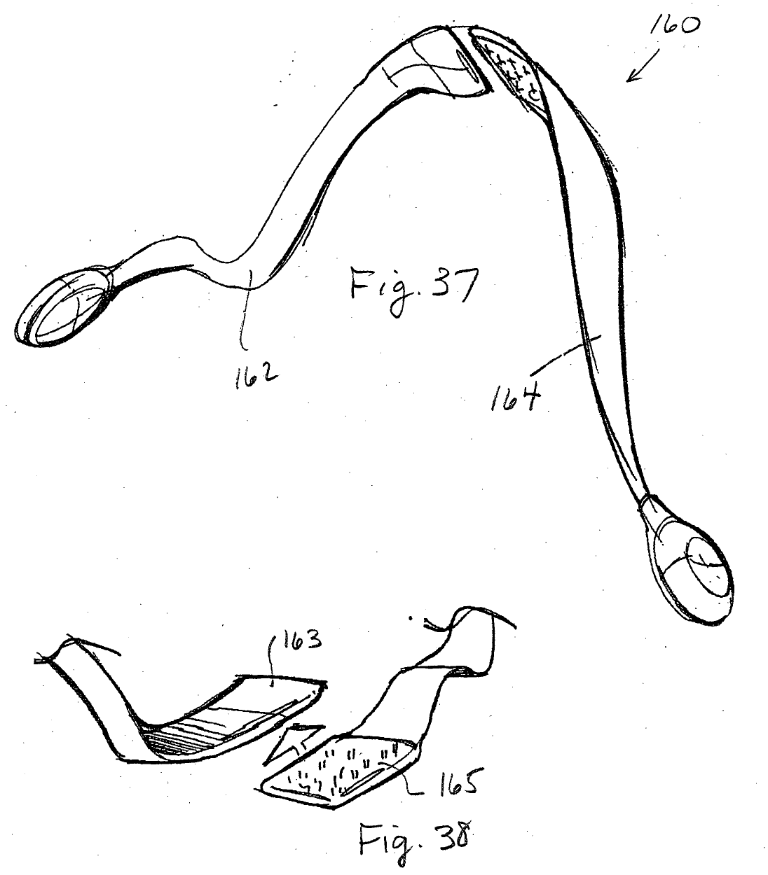

Other length adjustment mechanism may be employed. FIG. 34 illustrates another configuration 140 having legs 142, 144. Leg 142 includes a plurality of adjustment rings 146, each of the rings 146 having an internal aperture 146a. The second leg 144 includes a connector element 148 having an enlarged nub which fits into the aperture 146a of the ring 146, snapping into place. The nub 149 and/or the ring 146 is sufficiently flexible to allow insertion of the nub into the aperture 146a and removal therefrom. The user may adjust the overall length of the unit by inserting the connection element 148 in a selected one of the rings 146.

FIG. 36 illustrates another adjustable length attachment device 150. The device 150 has first and second legs 152, 154, the first leg 152 includes a buckle device 155 with an opening 156 to which a strap section 158 of the second leg 154 wraps through and wraps back around onto itself. The strap section 158 may include a suitable adjustable attachment mechanism such as hook and loop fastener material. The strap section 158 may be removed thereby adjusting the overall length of the unit 150.

FIGS. 37 and 38 illustrate another alternate attachment mechanism for a bib clip device 160. The device 160 includes first and second leg sections 162, 164 that are separate sections attachable by a suitable connection mechanism such as an adhesive system or a hook and loop combination, the hook section 165 being positioned on leg section 164 and the loop section 163 being positioned on the leg section 162. Depending upon the relative position of the section 165 as applied to section 153, the overall length of the unit may be adjusted.

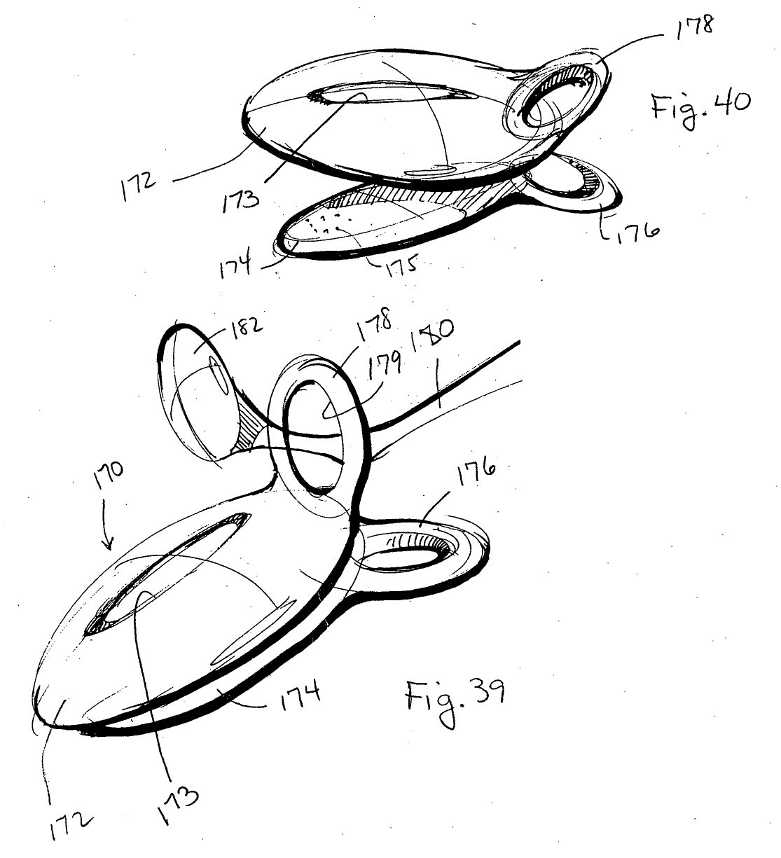

Other clip designs and clipping mechanisms may be employed for the end clips 60. FIGS. 39-40 illustrate an alternative design of an end clip 170 formed in a clam shell arrangement. In the closed position, the upper section 172 is urged against the lower section 174 by an internal spring mechanism, the closed position being shown in FIG. 39. To open the unit to allow insertion of the napkin for example, the user merely squeezes the flared end sections 176, 178 together which pivots the unit open as illustrated in FIG. 40. The internal surfaces of the unit may include teeth or nubs 175 to provide an enhanced friction securement surface for holding the napkin in place when the unit is closed. The top section 172 may include an opening 173. Such an opening may improve the grasping capability as well as reduce weight and cost of the unit.

The device 170 also includes an alternate attachment mechanism to the cord 180. In this configuration the cord 180 includes a nub or ball 182 which passes through an aperture 179 in flared end 178. The nub or ball 182 is sufficiently flexible in combination with the aperture 179 that it may be inserted therethrough, but is configured to resist withdrawal during normal use.

Thus one preferred configuration is a device for securing a napkin or drape (or other article such as a paper towel or the like) in position on a person's shirt-front, the device including a first leg section and a second leg section; a first clip mechanism attached to a distal end of the first leg section; a second clip mechanism attached to a distal end of the second leg section; a slide mechanism interconnecting the first leg section and the second leg section adjacent proximate ends thereof, wherein each of the first and second leg sections are slidably movable through the slide element providing for length adjustment, the device being positionable around a person's neck to position the first and second clip mechanisms on a person's shirt-front, wherein the first and second clip mechanisms are removably securable to a napkin or drape to form a bib over the person's shirt-front.

The first leg section may comprise a separate cord element terminating at one end attached to the first clip mechanism and terminating at its other end with an enlarged section. Similarly, the second leg section and second clip mechanism are preferably of an identical configuration to the first leg section and first clip mechanism.

The enlarged section at the end of the first leg section is preferably in the shape of a ball serving as a stop for preventing the cord element from sliding past and out of the slide mechanism. Other suitable shapes may be used besides the ball shape such as disk, bar, cone, or cube.

The cord element preferably comprises a flexible rubberized plastic material formed in the shape of an S-curve. The first and second leg sections may comprise separate elements (i.e. a single cord element) or may alternately comprise a single cord element terminating at one end attached to the first clip mechanism and terminating at its other end to the second clip mechanism.

It should be appreciated that features and elements in any one of the embodiments may be combined into any of the other embodiments given the teachings herein.

It will be obvious to those having skill in the art that many changes may be made to the details of the above-described embodiments without departing from the underlying principles of the invention. The scope of the present invention should, therefore, be determined only by the following claims.

1. A device for securing a napkin or drape in position on a person's shirt-front, comprising:
a first leg section and a second leg section;
a first clip mechanism attached to a distal end of the first leg section;
a second clip mechanism attached to a distal end of the second leg section;
a slide mechanism interconnecting the first leg section and the second leg section adjacent proximate ends thereof, wherein each of the first and second leg sections are slidably movable through the slide element providing for length adjustment,
wherein the device is positionable around a person's neck to position the first and second clip mechanisms on a person's shirt-front, wherein the first and second clip mechanisms are removably securable to a napkin or drape to form a bib over the person's shirt-front.

2. A device according to claim 1 wherein the first leg section comprises a separate cord element terminating at one end attached to the first clip mechanism and terminating at its other end with an enlarged section.

3. A device according to claim 2 wherein the second leg section and second clip mechanism comprises an identical configuration to the first leg section and first clip mechanism.

4. A device according to claim 2 wherein the enlarged section is in the shape of a ball serving as a stop for preventing the cord element from sliding past and out of the slide mechanism.

5. A device according to claim 2 wherein the cord element comprises a flexible rubberized plastic material formed in the shape of an S-curve.

6. A device according to claim 1 wherein the first and second leg sections comprise a single cord element terminating at one end attached to the first clip mechanism and terminating at its other end to the second clip mechanism.
